(19) United States
(12) Patent Application Publication
(10) Pub. No.: US 2007/0294299 A1
(43) Pub. Date: Dec. 20, 2007

(54) METHODS FOR USING GEOSPATIAL INFORMATION AS GEOSPATIAL SESSION FILES

(76) Inventors: Hanoch (Nuke) GOLDSTEIN, Burlington, MA (US); Jeffrey Gerard HARRISON, Woodbridge, VA (US)

Correspondence Address: BEYER WEAVER LLP, P.O. BOX 70250, OAKLAND, CA, 94612-0250, US

(21) Appl. No.: 11/624,097

(22) Filed: Jan. 17, 2007

Related U.S. Application Data
(60) Provisional application No. 60/759,940, filed on Jan. 17, 2006.

(51) Int. Cl. G06F 17/00

(52) U.S. Cl. 707/104.1; 707/E17.009

(57) ABSTRACT

Methods and apparatus are provided for storing, transporting and accessing a packaged collection of geospatial information. A geospatial toolkit including source, handler, and data modules is configured to access geospatial data from a variety of sources, parse the geospatial data, and provide geospatial content in a unified format. Parameters, including source, layer information, boundaries, and query filters, are set to allow retrieval of diverse geospatial data from different sources while providing a unified presentation on a system interface. The interface is associated with a framework that internally handles complex open-geospatial standards and services and facilitates open-geospatial development for Windows applications, on platforms such as Component Object Module (COM) and .NET. The information gathered in the source module and the data module is preserved with its corresponding visualization instructions.

### CROSS-REFERENCE TO RELATED APPLICATIONS

This application claims priority to U.S. Provisional Patent Application Ser. No. 60/759,940, filed Jan. 17, 2006 (Atty. Docket No. CARBP004P), entitled “METHODS AND APPARATUS FOR ACCESSING GEOSPATIAL INFORMATION”.

### TECHNICAL FIELD

The present invention generally relates to accessing, using and transporting geospatial content and geospatial services information. More specifically, techniques of the present invention provide tools for packaging multiple geospatial information sources, geospatial content and visualization information and providing the packaged information to applications in a unified format. The packaged content can be accessed, viewed and used regardless of the availability of a network or the content sources. The packaged content provides a base view where new data can be accessed via zoom, pan or similar actions.

### DESCRIPTION OF RELATED ART

Geospatial information is any data describing the location, characteristics, and/or features of a particular entity. Geospatial information is highly diverse and includes information from disparate sources such as terrain maps, aerial and satellite images, nautical charts, street maps, power grid data, transit route maps, and photographs. Components of geospatial information include addresses, coordinates, and identifiers.

A wide variety of applications use geospatial information. For example, photogrammetry applications use geospatial information in order to provide two dimensional or three dimensional measurements of an object. Resource development applications use geospatial information to discover and develop new oil and natural gas deposits. Power management applications use geospatial information to effectively route electricity in electric grids. Maritime applications use geospatial information to alert surface ships and submarines to maritime hazards.

The diversity of geospatial information has contributed to the diversity of sources of geospatial information. Many sources of geospatial information have developed their own specific and particular formats and media for maintaining the information. Geospatial information is stored on tape, disk, memory cards, and in databases in a wide range of specific and incompatible formats.

The increasing popularity of the Internet and the national and international need to share geospatial information in government and commercial systems has produced open specifications for geospatial information. However, mechanisms for accessing geospatial information remain limited, complicated, and resource intensive.

Organizations such as the Open Geospatial Consortium, Inc. (OGC) have developed specifications for open geospatial web services including Web Map Server (WMS). WMS defines a common mechanism for interacting with a web service that provides data such as raster maps. Another specification by OGC, the Web Feature Service (WFS), provides geospatial data in the form of Geography Markup Language (GML). GML is an extension of the W3C Extensible Markup Language (XML) that supports geospatial information.

Nonetheless, geospatial information is generally robust and detailed. Consequently, the specifications provided by entities such as the OGC are generally voluminous, complicated, and detailed. In many instances, specifications provided by entities such as the OGC are abstract and difficult to implement. The complex nature of geospatial information also makes implementation of specifications difficult. Application development complexity is increased because of the need to write detailed interfaces configured to access different types of geospatial data. Furthermore, each interface is typically data format specific. If a geospatial information format changes or if the developer wishes to access geospatial information from a different source, an application has to be rewritten or modified to accommodate the particularities of a new data format.

Techniques and mechanisms for providing open geospatial information and services to software developers are limited. For example, developers using a proprietary framework such as the .NET and Component Object Module (COM) provided by Microsoft Corporation of Redmond, Wash. have limited access to tools and interfaces that allow efficient access to diverse geospatial information. Specifically, there are no software development toolkits for these frameworks that include software libraries that are not bound to a Geographic Information System (GIS) and are not dependent on any third party software.

Consequently, there is a need for techniques and mechanisms that overcome the limitations associated with accessing geospatial information and implementing open geospatial applications in frameworks such as .NET. Moreover, most geospatial content will be accessed and displayed as layers of information that build a singular view. There is no existing common framework that allows a view of several layers of geospatial content from multiple sources and source types, such as Web services or databases, to be preserved and shared between different software applications as a packaged geospatial software object that includes handlers for the content, the content itself and rendering instructions and is usable both online and offline.

### BRIEF DESCRIPTION OF THE DRAWINGS

The disclosure may best be understood by reference to the following description taken in conjunction with the accompanying drawings, which illustrate particular example embodiments.

FIG. 1 is a diagrammatic representation showing usage of one example of a geospatial framework.

FIG. 2a is a diagrammatic representation showing components of a geospatial framework.

FIG. 2b is a diagrammatic representation showing a source-handler-data architecture supporting different sources of geospatial information.

FIG. 3a is a diagrammatic representation showing a how a geospatial layer is rendered to an output image via a framework's graphic instructions.

FIG. 3b is a diagrammatic representation showing how a geospatial layer is rendered to an output image via an external rendering object.

FIG. 4a is a diagrammatic representation showing a packaged software object of a geospatial layer where the data is dynamically generated by a geospatial service.

FIG. 4b is a diagrammatic representation showing a packaged software object of a geospatial layer from a static data source.

FIG. 4c is a diagrammatic representation showing a collection of geospatial layer objects to provide a stacked representation of a complete data view as a single packaged geospatial software object.

FIG. 5 is a diagrammatic representation showing the export and import of packaged geospatial content in various methods.

FIG. 6a is a flow process diagram showing how a geospatial software object is created for a single layer and then added to a collection of geospatial layers.

FIG. 6b is a flow process diagram showing how an imported geospatial collection can resume the work session and update the view according to new region parameters.

FIG. 7 is a diagrammatic representation depicting how a packaged geospatial software object created by one user on a software application is transported to another user that uses a different application which then resumes the session by interacting with the map view.

### DESCRIPTION OF EXAMPLE EMBODIMENTS

Reference will now be made in detail to some specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of fibre channel networks. However, it should be noted that the techniques of the present invention can be applied to different variations and flavors of networks. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Furthermore, techniques and mechanisms of the present invention will sometimes be described in singular form for clarity. However, it should be noted that some embodiments can include multiple iterations of a technique or multiple instantiations of a mechanism unless noted otherwise. For example, a processor is used in a variety of contexts. However, it will be appreciated that multiple processors can also be used while remaining within the scope of the present invention.

Overview

Methods and apparatus are provided for storing, transporting and accessing a packaged collection of geospatial information. A geospatial toolkit including source, handler, and data modules is configured to access geospatial data from a variety of sources, parse the geospatial data, and provide geospatial content in a unified format. Parameters, including source, layer information, boundaries, and query filters, are set to allow retrieval of diverse geospatial data from different sources while providing a unified presentation on a system interface. The interface is associated with a framework that internally handles complex open-geospatial standards and services and facilitates open-geospatial development for Windows applications, on platforms such as Component Object Module (COM) and .NET. The information gathered in the source module and the data module is preserved with its corresponding visualization instructions.

Each layer of information is stored in a collection that preserves the information required to view and use each geospatial layer as well as the order of the layers in the packaged collection. The packaged information can be stored or ported to another software application that supports the underlying framework. The work session represented by the packaged collection of geospatial information created by one user on a software application is transported to another user that uses a different application which then resumes the session by interacting with the map view.

### Example Embodiments

The advancement in computing hardware and software as well as the emergence of technologies such as the Internet are changing the field of Geographic Information Systems (GIS). The movement toward a more distributed and mobile society and the need to utilize and share geospatial information and services has produced an effort by organizations such as the World Wide Web Consortium (W3C) and Open Geospatial Consortium (OGC) to develop open services that allows access to and distribution of geospatial information.

Conventionally, most geospatial information was managed by different vendors in numerous forms and formats. Numerous proprietary formats were used to support maps, features and other geospatial information. Having numerous formats creates a major problem when tackling the task of information sharing between systems and organizations. Some conventional commercial solutions cope with the task of transporting information from one vendor to another by providing solutions that support numerous formats and can translate one format to another format. However, conventional solutions are limited in many ways. For example, support of formats is bound to data sources the tool is designed to work with, and the introduction of a new version or an unsupported data format can not be handled without updates or modifications to the software tools. Furthermore, translation tools may be very complicated, resource intensive and software heavy solutions that are susceptible to specification implementation errors by the solution provider. In addition, there is no existing solution that enable the transport of a complete view, comprised of multiple data layers from several local or remote sources, to different systems and then continue the interaction with the content providers from the importing system.

Consequently, the techniques and mechanism of the present invention provide tools to allow a user to efficiently and effectively preserve and transport a complete view and session states and access that view from other software applications. According to various embodiments, a system framework is provided to hide the complexity of the services and content, allowing a user to access and use multiple geospatial services through a unified set of methods and properties through technologies such as the .NET framework.

In one embodiment, a geospatial framework is provided through a geospatial interface for software development. The interface facilitates geospatial development. The geospatial framework includes software libraries that are not bound to any specific Geographic Information System (GIS) and are not dependent on any third party software. In one example, the toolkit is based on the Microsoft .NET or COM framework.

According to various embodiments, the geospatial data layers are implemented using an architecture developed to handle geospatial data from a variety of sources. The interface used for implementation includes a source-handler-data architecture. Each geospatial service or source is handled using three main modules. The source module handles the information needed to access the data source. The handler module manages the interaction with the data source and stores the geospatial information into a data component. The data module stores and manages data objects. The source-handler-data architecture allows access to a variety of supported data sources in a variety of formats. The architecture allows processing of the information and maintenance of the stored data. Using the source-handler-data architecture, the techniques of the present invention provide mechanisms to describe a separation between the data source and the data content.

The separation of source and content allows handling of different sources in a unified data management system. For example, one data source may be a web service that returns raster maps while another source may be a file that points to some spatial data and a map image file. The two sources have a common data type but completely different providers. According to various embodiments, the architecture calls for a handler component that manages the interaction with the source, the management of the imported data and storage of the parsed data. By using a source-handler-data architecture, developers can efficiently access geospatial information from a variety of sources and store and manage the information for application use by using discrete, interoperable components.

Source, handler and data modules can be represented as software objects. Using available software techniques, such as .NET serialization, these objects can be packaged and stored in a transportable software object. The framework provides the means to package, preserve and transport the software objects. Moreover, a collection of these objects can be created to represent a singular container object, thus aggregating the content of the contained layers into a single object.

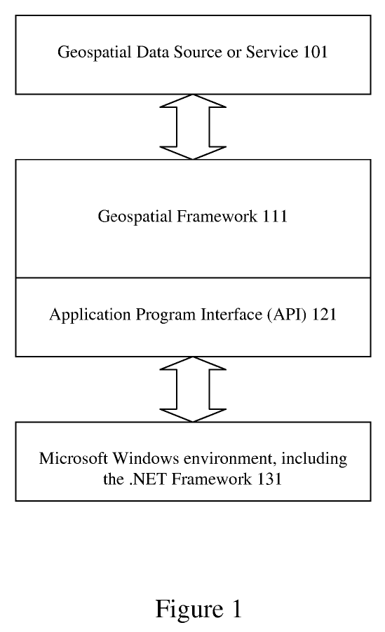

FIG. 1 is a diagrammatic representation showing usage of an open-geospatial toolkit as a framework for geospatial development. According to various embodiments, a detachable open geospatial toolkit or framework 111 provides a platform for easily developing geospatial applications. The open geospatial toolkit 111 is associated with a unified application program interface (API) 121. The unified application program interface 121 allows efficient development in an environment such as Microsoft Windows using a framework such as .NET 131. The open geospatial toolkit 111 allows a developer to obtain data from a variety of geospatial data sources or services 101. According to various embodiments, the toolkit 111 provides a way to interact with any supported service such as Web Map Service (WMS), Web Feature Service (WFS) or Geography Markup Language (GML). The toolkit 111 provides a sophisticated parser to deal with the complexities of geospatial information through an open API and a versatile feature data module. The toolkit 111 can be expanded to support additional data formats and data services with the simple addition of components or modules into the toolkit 111.

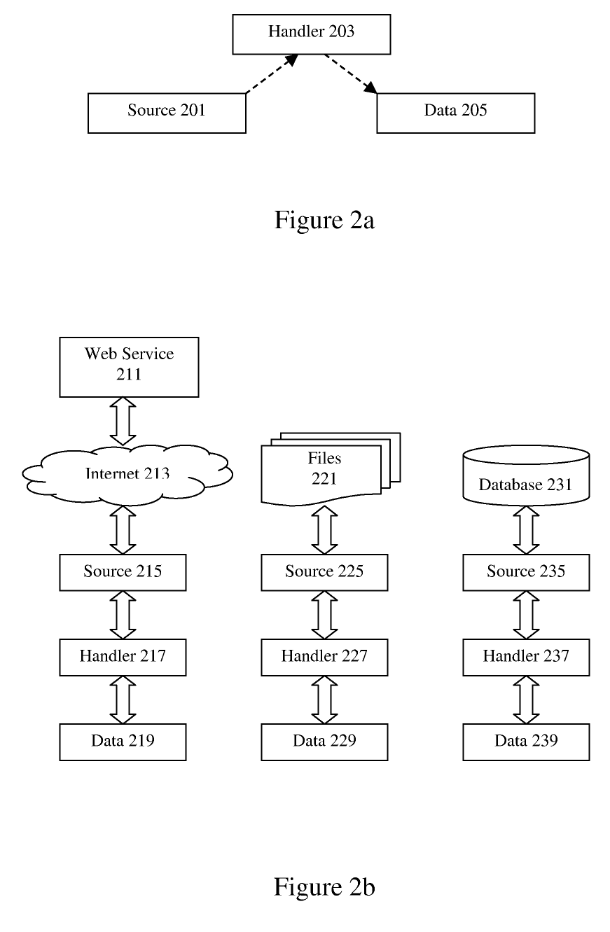

FIG. 2a is a diagrammatic representation showing components of an open geospatial toolkit. According to various embodiments, the toolkit includes a source module 201, a handler module 203, and a data module 205. The source module 201 handles the information needed to access the data source. The handler module 205 manages the interaction with the data source and stores the geospatial information into a data component. The data module 205 stores and manages data objects. If additional sources of data are developed, the geospatial framework or toolkit can be extended by simply adding additional modules to handle different types of data. In some embodiments, no other modifications are needed as updates to the geospatial framework are modular and component-based.

FIG. 2b is a diagrammatic representation showing a source-handler-data architecture supporting different sources of geospatial information. A source module 215 is coupled to handler module 217. The handler module 217 is coupled to the data module 219. The source module 215 is connected to access geospatial information from a web service 211 over a network such as the Internet 213. A source module 225 is coupled to handler module 227. The handler module 227 is coupled to the data module 229. The source module 225 is connected to access geospatial information from geospatial information files 221. The data in files 221 may be provided in a different format than data provided by web service 211. Another source module 235 is coupled to handler module 237. The handler module 237 is coupled to the data module 239. The source module 235 is connected to access geospatial information from a database 231. The geospatial information in database 231 may again be different than the than the information in files 221 or web service 211.

The techniques of the present invention allow separation between the data source and the data content. The separation allows handling of different sources in a unified data management system. For example, one data-source may be a web-service that returns raster maps while another source may be a file that points to some spatial data and a map image file. The two sources may have a common data type, a raster map, but completely different providers. The architecture includes a handler component that manages interaction with the source and also controls the transfer, parsing, and storage of data.

In one particular example, the framework base modules include a Core.Base module that provides the essentials of a source-handler-data. This module includes the basic building blocks for the architecture including interfaces that define data sources, handlers and data types. A Core.Geometries module provides basic handling of geometries such as point, line, and polygon. In addition, geometry collection classes are provided under this namespace. A Core.Features module provides sophisticated data and metadata capabilities. This module can support a nested metadata model with embedded multiple geometries (through the geometries module) per feature. The robust nature of this data is simplified with analysis tools provided by the feature analysis class. This class provides tools to find and access information within complex data structures. A Core.Drawing module provides techniques to render data objects into a drawing surface, such as a bitmap. This module includes a default rendering functionality along with the ability to customize and extend the functionality with user defined extensions.

In one example, the Core.GML module provides geospatial markup language (GML) parsers. The Tools.Core.WFS module provides source and handler components for accessing any Web Feature Service (WFS) and Geography Markup Language (GML). A WFS is a stateless service where a geospatial layer is provided as GML by querying the layer information according to a bounding-box and specific filtering parameters. GML is parsed and stored in a DataFeatures module using GML parsers.

The Tools.Core.WMS module provides source and handler components for accessing and handling any Web Map Service (WMS). Raster maps are stored in the DataRaster data module. This module can handle the interaction with the stateless WMS by querying the service for a specific layer using a bounding-box and filtering parameters

Although source modules, handler modules, and data modules can be implemented in a variety of manners, the techniques of the present invention contemplate implementing them as portable, self-contained modules using the .NET framework. According to various embodiments, the toolkit and the source, handler, and data modules are implemented using base modules.

The Tools.Core.GeoObject. is a class that can store a Handler object that consequentially includes source and data objects, when storing content from a service. Alternately, the Tools.Core.GeoObject can contain a data module for static data storage. The Tools.Core.GeoObject module also stores rendering instructions for the data, either in form of styling instructions for the underlying framework or as a software object containing a more elaborate rendering functionality. A software object created from a Tools.Core.GeoObject module can be preserved in a binary or other form according to techniques such as .NET serialization. The object and any contained objects can then be preserved and transported as a file or stream and be imported at a later time.

The Tools.Core.GeoObjectCollection is a class that contains a collection of Tools.Core.GeoObject type objects. This class preserved the content of each layer while providing an ordered list of the contained layers. This class can be preserved as a single object through techniques such as .NET serialization, thus aggregating the contained information into a single transportable file or stream

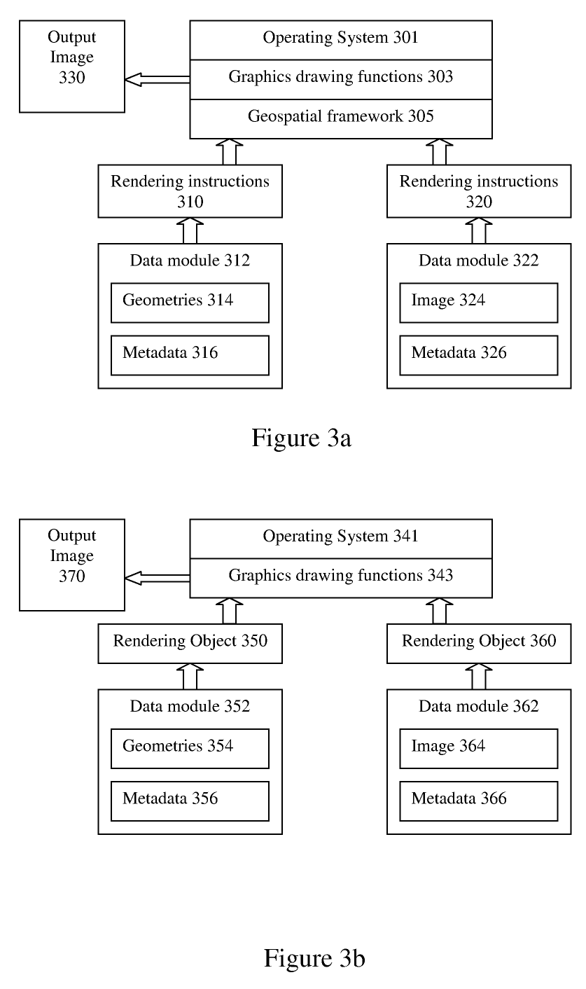

FIG. 3a is a diagrammatic representation showing a data module 312 that contains features with geometries 314 and metadata 316 such as additional properties describing the features. The data is rendered to a target or output image 330 by applying rendering instructions 310 that are executed by the operating system 301 and the graphic functionality or graphics drawing functions 303 supported via the geospatial framework 305 and the operating system 301. For example, a point can be instructed to be drawn as a full circle with a certain radius and a specific fill color and pattern. The geospatial framework 305 will convey these instructions to the graphic functions 303 supported by the operating system 301. Another type of rendering instructions 320 can apply to imagery 324 and it's related metadata 326 contained in a data layer 322. For example, the metadata 326 can instruct the framework 305 to apply an alpha blend when creating the target image 330.

FIG. 3b is a diagrammatic representation showing a data module 352 that contains features with geometries 354 and metadata 356 such as additional properties describing the features. The data is rendered to a target or output image 370 by applying complex rendering instructions embedded in a software component 350. The rendering component or object 350 contains complex functionality that enhances the basic graphic functionality 343 executed by the operating system 341. For example, a set of points can be instructed to be drawn as a circles with a line path drawn to connect them. The rendering object 350 will convey these instructions to the graphic functions 343 supported by the operating system 341 by processing all the points found in the data layer 352. This type of visualization requires familiarity with the content of the displayed information that may not be available in the underlying framework. Another type of rendering object 360 can apply to imagery or image 364 and it is related metadata 366 contained in a data layer 362. For example, the metadata 366 can instruct the rendering object 360 to extract only the red band of the source image 364 when producing the target image 370.

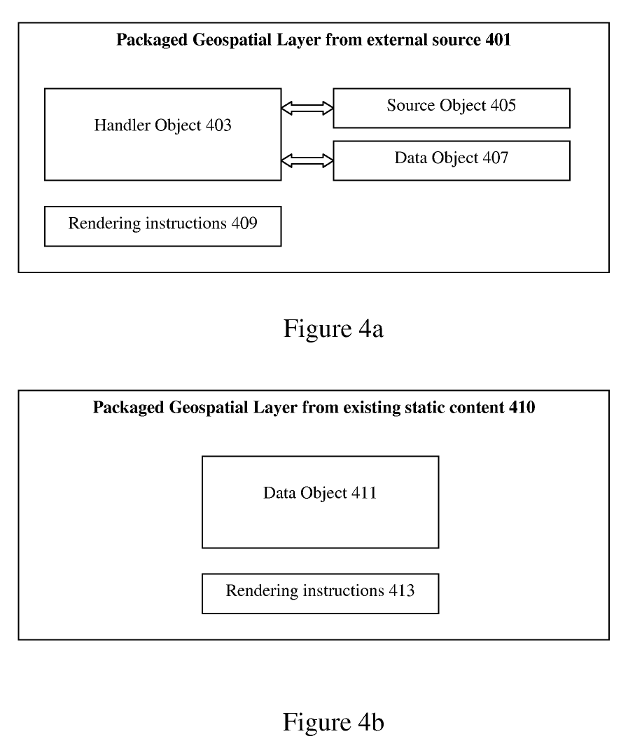

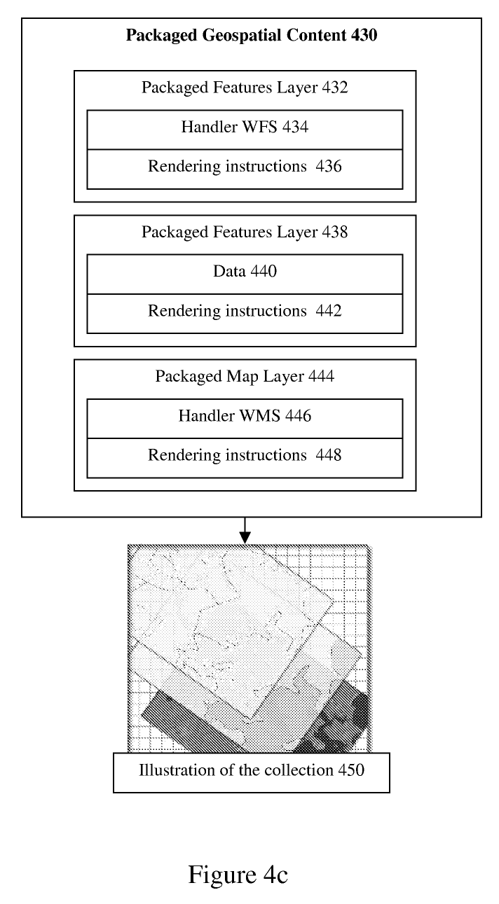

FIG. 4a is a diagrammatic representation showing a packaged geospatial layer 401 retrieved from a service represented by a source module 405 and a data module 407 maintained by a handler module 403. The information in the data module 407 allows the visualization and transportation of a view regardless of the state of the network or the providing service. The packaged geospatial layer also carries a set of rendering instructions 409. These rendering instructions 409 may use framework defined capabilities to draw the contents of the data module 407.

FIG. 4b is a diagrammatic representation showing a packaged geospatial layer 410 retrieved from a static data source represented by a data module 411. Static data cannot be updated dynamically and does not require any interaction with its source; for example, data read from a local file can be stored in the data module 411. The packaged geospatial layer also carries a set of rendering instructions 413. These rendering instructions 413 may use framework defined capabilities to draw the contents of the data module 411.

FIG. 4c is a diagrammatic representation showing a packaged geospatial collection or content 430. According to various embodiments, the geospatial collection 430 contains packaged features layer 432 that has access information and data from a Web Feature Service (WFS) 434 with an included set of rendering instructions 436. The collection 430 also includes a packaged features layer 438 from a static data source read into a data object 440 and has specific rendering instructions 442. The collection 430 also includes a map layer 444 that accesses a Web Map Service (WMS) 446 and has specific rendering instructions 448. The collection 430 maintains an ordered list of the layers and their access information as well as rendering parameters. The collection can be used to draw a single map that is composed of the contained layers (illustration of collection) 450.

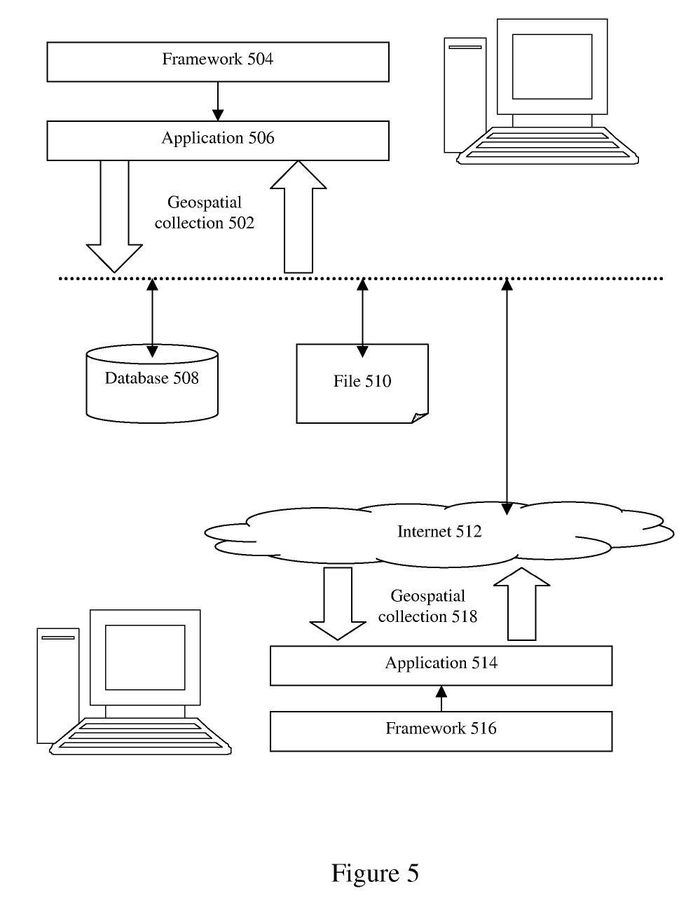

FIG. 5 is a diagrammatic representation showing various embodiments of exported and imported geospatial collections. An application 506 supports geospatial functionality through the system's framework 504 can export or import a packaged collection of layers (geospatial collection) 502 to a data storage mechanism such as database 508 or file 510. The exported file contains a collection of data layer and information regarding the providing service and how to access these layers. The packaged collection 502 can be transported through a network such as the Internet 512. Another application 514 that uses a compliant framework 516 can read the packaged collection (geospatial collection) 518 of maps and resume the session by panning or zooming. Any layer that contains information regarding the service will be updated according to the newly requested region of interest.

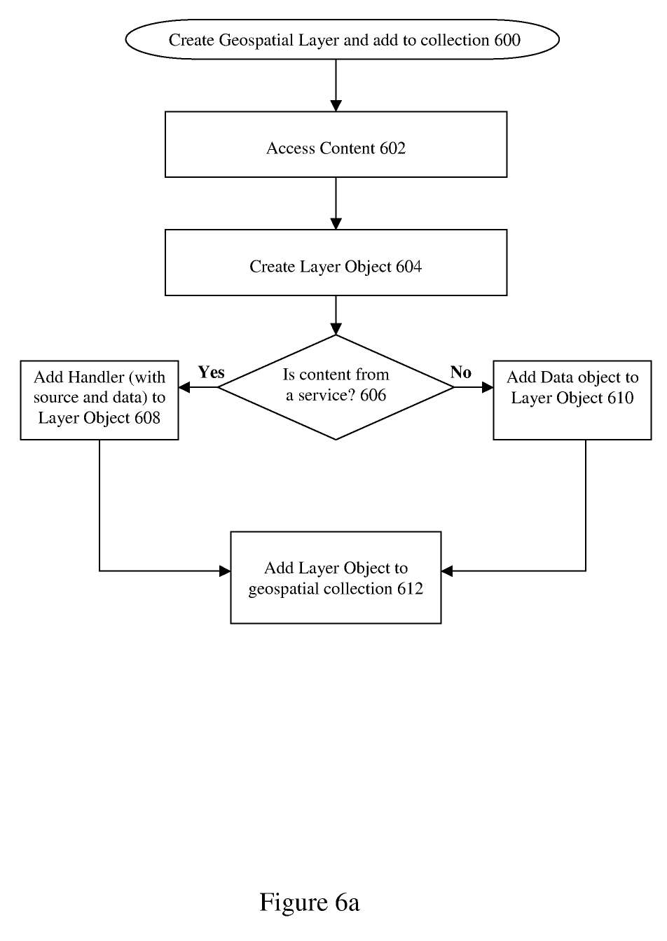

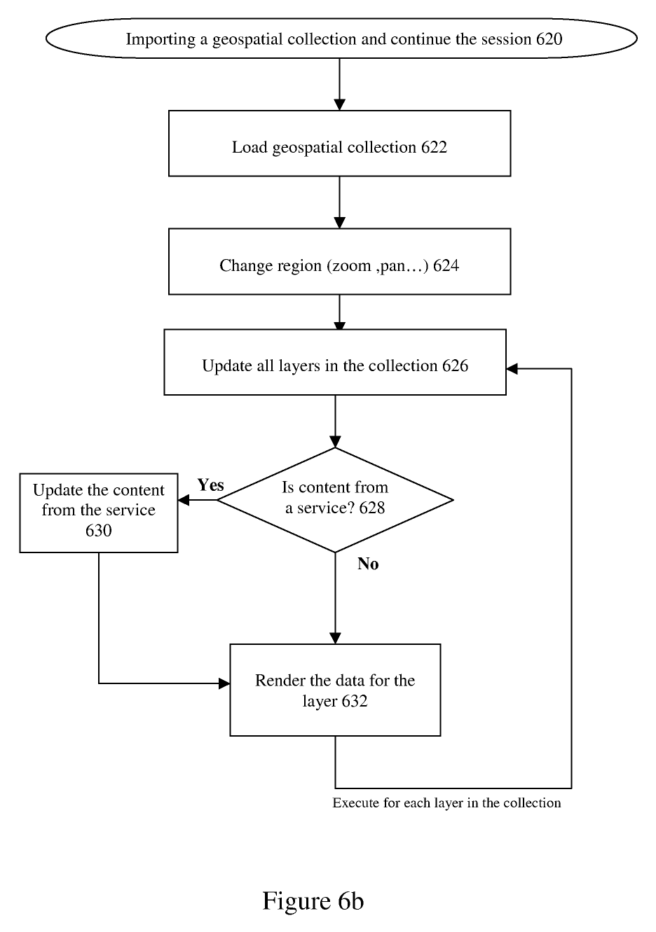

FIG. 6a is a flow process diagram showing a technique for creating a geospatial layer and adding it to the packaged collection at 600. At 602, a new source component is created and the data is accessed. According to various embodiments, the new component created corresponds to a geospatial data service provider or optionally read from a static source such as a file. At 604, the layer is wrapped in a containing object. At 606, the system decides how to contain the information according to the source provider. At 608, the layer is from a geospatial service and the information used to access the service including the current parameters used to query and render the information are packaged. At 610, the layer is from a static source such as a file that contains geospatial information but has no dynamic service associated with it where new information can be updated according to different parameters; therefore, the only information used is the contained geospatial data. At 612, the packaged layer is added to a collection of layers. Typically, layers are ordered and stacked to create a single view where all or some of the layers are displayed. For example, a legend can list the different layers with a check-box that allows to turn on or off each layer in the general view.

FIG. 6b is a flow process diagram showing a technique for importing a geospatial collection and changing the viewing parameters at 620. At 622, a packaged collection is read into the application. The read collection includes a collection of layers and information regarding their source provider and access parameters on how to get that view. The contained list can be viewed by simple rendering the contained data in each layer. At 624, the application changes the required viewing area and parameters. For example, a user zooms or pans the image to get updated information about a new region of interest. At 626, the system is ordered to refresh the data according to a new region of interest and will loop through each layer to get new data if available. At 628, the system will decide if the layer is based on a static or dynamic source. Static data will not have any updates associated with it and therefore will be rendered according to the new region with the available data at 632. At 630, dynamic sources, such as web service, can fetch new information according to the new region of interest. Once the information is available the data will be rendered to the map 632. The process will loop through all layers, rendering the new data in order to create a stacked view of the layer to a single map view.

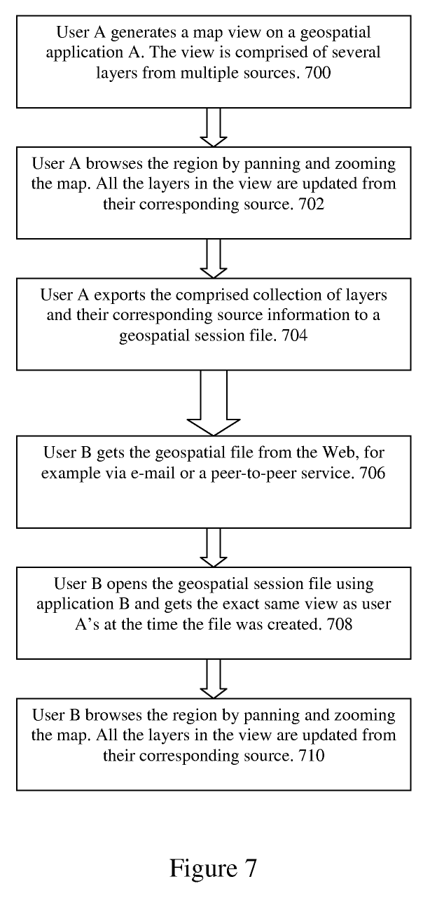

FIG. 7 is a diagrammatic representation showing how a geospatial collection is created by one user on an application and then transported to a different user on a different application where the second user can continue browsing the region for new geospatial content. In this example, at 700, a user A creates a map based on several layers of geospatial content from multiple sources. This view can contain raster maps such as satellite imagery from a Web Map Service, hydrology data such as rivers and lakes from a Web Feature Service, transportation information such as roads and railroads from another Web service. The user can pan, zoom and style the data at 702 while receiving updates from the corresponding services. The user can then export the complete package of layers and share it with another user using a geospatial session file at 704. A different user, user B, can receive the packed collection via various communication methods at 706. In one example, a user can read the geospatial session file from a peer-to-peer file sharing service. Another example can be an e-mail attachment. The user B can display the exact same view as was packaged by the originating user at 708. Since the packaged collection of layers include the information on how to access the correlating services, the user can now change the region of interest thus generating updated content for the new region. At 710, the user B can pan, zoom and style the data while receiving updates from the corresponding services.

The techniques and mechanisms of the present invention can be implemented in a computer system having one or more processors. In one embodiment, the computer system includes one or more processors, memory, and a network interface allowing the computer system to communicate with external entities such as geospatial information servers. The techniques and mechanisms of the present invention can be implemented in a wide variety of computer system configurations. For instance, instructions and data for implementing the above-described invention may be stored on a disk drive, a hard drive, a floppy disk, a server computer, or a remotely networked computer. Computer systems and computing systems include servers, laptops, desktops, portable devices, portable gaming devices, personal digital assistants, and any device having a processor and an interface.

While the invention has been particularly shown and described with reference to specific embodiments thereof, it will be understood by those skilled in the art that changes in the form and details of the disclosed embodiments may be made without departing from the spirit or scope of the invention. For example, embodiments of the present invention may be employed with a variety of network protocols and architectures. Accordingly, the present embodiments are to be considered as illustrative and not restrictive, and the invention is not to be limited to the details given herein, but may be modified within the scope and equivalents of the appended claims.

What is claimed is:

1. A method, comprising:
starting a session;
receiving first geospatial data including first layer and boundary information from a first source, the first geospatial data received at a first computing system;
receiving second geospatial data including second layer and boundary information from a second source, the second geospatial data received at a second computing system;
maintaining the first geospatial data and the second geospatial data with corresponding visualization instructions at the first computing system;
transmitting session state information from the first computing system to a second computing system, wherein the second computer system uses the first geospatial data, the second geospatial data, and session state information to resume the session.

2. The method of claim 1, further comprising transmitting the first geospatial data, the second geospatial data, and a session file from the first computing system to the second computing system.

3. The method of claim 2, wherein the session state information is transmitted over a peer-to-peer network.

4. The method of claim 2, wherein the session state information is transmitted as an email attachment.

5. The method of claim 1, wherein the session state information allows the second computing system to have a complete view of the first geospatial data and the second geospatial data.

6. The method of claim 5, wherein the session resumes when a user interacts with the first geospatial data and the second geospatial data at the second computing system.

7. The method of claim 1, wherein the first geospatial data and the second geospatial data are received in different formats.

8. The method of claim 1, wherein the first computing system includes a source module that handles the information needed to access the first source and the second source.

9. The method of claim 1, wherein the first computing system includes a handler module that manages the interaction with the first source and the second source and stores the first geospatial data and the second geospatial data in one or more data components.

10. The method of claim 1, wherein the first computing system includes a data module that stores and manages the first geospatial data and the second geospatial data.

11. The method of claim 1, wherein the first geospatial data further includes a query filter.

12. The method of claim 1, wherein the second geospatial data further includes a query filter.

13. A computer system, comprising:
an input interface operable to receive first geospatial data and second geospatial data, the first geospatial data including first layer and boundary information from a first source, the second geospatial data including second layer and boundary information from a second source;
a processor operable to start a session and maintain the first geospatial data and the second geospatial data with corresponding visualization instructions; and
an output interface operable to transmit session state information to a remote computer system, wherein the remote computer system uses the first geospatial data, the second geospatial data, and session state information to resume the session.

14. The computer system of claim 13, wherein the output interface is further operable to transmit the first geospatial data, the second geospatial data, and a session file to the remote computer system.

15. The computer system of claim 14, wherein the session state information is transmitted over a peer-to-peer network.

16. The computer system of claim 14, wherein the session state information is transmitted as an email attachment.

17. The computer system of claim 13, wherein the session state information allows the remote computer system to have a complete view of the first geospatial data and the second geospatial data.

18. The computer system of claim 17, wherein the session resumes when a user interacts with the first geospatial data and the second geospatial data at the remote computer system.

19. The computer system of claim 13, wherein the first geospatial data and the second geospatial data are received in different formats.

20. A computer readable medium, comprising:
computer code for starting a session;
computer code for receiving first geospatial data including first layer and boundary information from a first source, the first geospatial data received at a first computing system;
computer code for receiving second geospatial data including second layer and boundary information from a second source, the second geospatial data received at a second computing system;
computer code for maintaining the first geospatial data and the second geospatial data with corresponding visualization instructions at the first computing system;
computer code for transmitting session state information from the first computing system to a second computing system, wherein the second computer system uses the first geospatial data, the second geospatial data, and session state information to resume the session.
